(19) United States
(12) Patent Application Publication
(10) Pub. No.: US 2010/0066659 A1
(43) Pub. Date: Mar. 18, 2010

(54) METHOD AND SYSTEM OF DYNAMIC BACKLIGHT MODULATION

(76) Inventor: Pei-Chuan LIU, Taipei (TW)

Correspondence Address: Muncy, Geissler, Olds & Lowe, PLLC, P.O. BOX 1364, FAIRFAX, VA, 22038-1364, US

(21) Appl. No.: 12/209,727

(22) Filed: Sep. 12, 2008

(51) Int. Cl. G09G 3/36

(52) U.S. Cl. 345/102

(57) ABSTRACT

A method and system for dynamic backlight modulation are provided for a liquid crystal display. An image signal is analyzed to acquire an intensity and distribution. Based on the acquired intensity and distribution, a processor controls the backlight intensity of a backlight module for a liquid crystal display. A modulation unit of dynamic distribution and enhancement unit of dynamic signal dynamically modify the contrast distribution and intensity of the image signal. The system improves the drawbacks of low brightness contrast and high brightness of a black frame.

### BACKGROUND OF THE INVENTION

1. Field of the Invention

The present invention relates in general to a method and system of dynamic backlight modulation about images and in particular to a method and system of dynamic backlight modulation about images displayed on a liquid crystal display.

2. Description of the Prior Art

Hardware of a flat display, for example, backlight module, display or driving circuit, has been mature for many years not to play an important role on the improvement of display qualities that people still pursue. One of the qualities for display is relevant to the brightness (cd/m²) of the flat display. There are two methods to improve the brightness for display: increase the luminous flux of light of a LCD display and the brightness of background light. However, too bright display may fatigue a viewer's eyes. Reducing the contrast of pure white and pure black may degrade the performance of level and gray scale. Generally, contrast is the ratio of brightness respectively in the whole white and whole black display. For a traditional liquid crystal display, a cold cathode fluorescent lamp (CCFL) is used to the illumination unit of a backlight source. CCFL provides all of displayed frames with uniform brightness. Thus, one improvement way on the contrast to increase the contrast between a signal and a uniform gray scale is implemented by static enhancement technology. Another improvement way is to adjust the light flux by arranging the orientations of liquid crystals to generate darker hues. However, the alignment time of liquid crystals may cause the issue of light leakage in the neighborhood. Light leakage may further cause the display of a dark frame in a bright or blur way. Thus, it is still necessary to resolve the issue of the light leakage.

Currently, LED is used to the illumination unit of a backlight source for LCD. LED is advantageous to vivid display effect by the step control technology and the power reduction up to 80%. Compared with CCFL, LED has a higher performance on power utilization because light or dark brightness is efficiently controlled to meet with the brightness requirement of the images when LED is used as a light source of LCD. A two-dimensional backlight brightness control for the display of vivid visual effects, strong contrast, wide color range and good color saturation may be implemented by a set of addressable LED array.

There were various brightness control technologies in the backlight control of CCFL in the past years. For example, a zero-dimensional dimming technology satisfies the brightness requirement of images by making the whole backlight dark. One-dimensional modulation performs the modulation of single axis, for example, the brightness of one set of CCFL is modulated. The brightness control of the LED backlight has been developing to become workable because of the cost reduction of LED and the improvement of performance. Moreover, it is possible for LED to develop two-dimensional modulation (horizontal lines and vertical lines) because LEDs are arranged in an array easily and the array is easily controlled respectively. It was impossible for CCFL to be implemented in the past. For the two-dimensional modulation, most of light is emitted on the back of light area on a frame, and little light is emitted on the back of dark area on the frame. The control of two-dimensional LED backlight has more advantageous when the display is equipped with a RGB color LED, instead of a white LED. The RGB color LEDs may provide a wider color range for the brightness of a conventional backlight LCD panel. Thus, RGB backlight LED may provide brighter and higher saturation color display. For example, the color space of RGB may be mapped the color space of LED backlight with an adaptive saturation control. For such a mapping method, the saturation of a color may be as bright as one displayed by LED, without the changes of the white, skin and mild color of a frame or an image. The RGB LED in a two-dimensional array may be respectively controlled on the basis of monochromatic color so as to reduce the power consumption, improve the color range and contrast. For example, a color filter, which may absorb light to cause about 70% light loss, weights 19% in a total cost. The yield of a panel may be improved and the manufacturing cycle is reduced once the color filter is removed from a LCD panel. The removal of the color filter may improve 70% of the amount of emitting light to further reduce 70% of the amount of the LEDs, though LEDs as the backlight of LCD may raise 25% of the cost higher than CCFL as the backlight of LCD in field sequence process. The 70% reduction of LEDs means 70% reduction of the heat generated by the LEDs, as well as the power consumption. Furthermore, it is not necessary for the field sequence process to divide a pixel into three sub-pixels. Thus, the amount reduction of TFT may be up to ⅓ of the original amount of TFT which is equal to enlarge 3 times of the pixel area. That is, the triple resolution may be implemented based on a uniform screen dimension or a uniform pixel area.

Accordingly, it is a trend to improve the display quality by improving the distribution among signals and adjusting light source with the control of the two-dimensional LED backlight.

### SUMMARY OF THE INVENTION

The present invention is directed to dynamically modulating and enhancing the contrast among signals for an input signal. Meanwhile, the drawbacks of the brightness with low contrast and too light black frame are improved by dynamically controlling the backlight of display.

The present invention is also directed to adjust brightness levels by dynamically modulating and enhancing the contrast among signals for an input signal. The input signal is modulated with the redistribution and the adjustment of backlight range based on the brightness levels to enhance the whole display quality of LCD display.

The present invention is directed to redistribute the distribution of signal intensity (gray scale average of signal) to generate a new transfer function. The primary input signal is converted by the transfer function to a transferred signal output for better display performance.

Accordingly, one embodiment of the present invention provides a system of dynamic two-dimensional backlight modulation. A gray-scale dividing unit is configured for receiving a gray-scale signal and dividing the gray-scale signal into a plurality of gray-scale zone signals. A gray-scale signal analyzing-and-separating unit electrically coupled to the gray-scale dividing unit is configured for receiving and analyzing the gray-scale zone signals for generating a gray-scale distribution average and a gray-scale distribution contrast average of the gray-scale signal. A gray-scale backlight modulation unit electrically coupled to the gray-scale signal analyzing-and-separating unit is configured for receiving the gray-scale distribution average and generating a gray-scale backlight control signal output according to the gray-scale distribution average. A gray-scale signal contrast enhancement unit electrically coupled to the gray-scale signal analyzing-and-separating unit is configured for receiving the gray-scale distribution contrast average and the gray-scale backlight control signal output to generate a variation of the gray-scale distribution contrast average. A unit of synthesizing-and-dividing gray-and-color light into RGB monochromatic light signal electrically coupled to the gray-scale signal contrast enhancement unit to compensate a RGB color signal is configured for varying the variation of the gray distribution contrast and converting the RGB color signal into the monochromatic light signal. A monochromatic dividing unit is configured for receiving a red, green or blue monochromatic signal and dividing the red, green or blue monochromatic signal into a plurality of monochromatic zone signals. A monochromatic signal analyzing-and-separating unit electrically coupled to the monochromatic dividing unit is configured for receiving and analyzing the monochromatic zone signals for generating a monochromatic distribution average and a monochromatic distribution contrast average of the monochromatic signal. A monochromatic backlight modulation unit electrically coupled to the monochromatic signal analyzing-and-separating unit is configured for receiving the monochromatic distribution average and the gray-scale backlight control signal output to generate a red, green or blue backlight control signal output. A monochromatic signal contrast enhancement unit electrically coupled to the monochromatic signal analyzing-and-separating unit is configured for receiving the monochromatic distribution contrast average and the red, green or blue backlight control signal output to generate a RGB color-mixed signal.

A method of dynamic two-dimensional backlight modulation includes the following steps: dividing a gray-scale signal into a plurality of gray-scale zone signals; analyzing the gray-scale zone signals for generating a gray-scale distribution average and a gray-scale distribution contrast average of the gray-scale signal; generating a gray-scale backlight control signal output according to the gray-scale distribution average; generating a variation of the gray-scale distribution contrast average according to the gray-scale distribution contrast average and the gray-scale backlight control signal output; compensating a RGB color signal for varying the variation of the gray distribution contrast and converting the RGB color signal into the monochromatic light signal; dividing a red, green or blue monochromatic signal into a plurality of monochromatic zone signals; analyzing the monochromatic zone signals for generating a monochromatic distribution average and a monochromatic distribution contrast average of the monochromatic signal; generating a red, green or blue backlight control signal output according to the monochromatic distribution average and the gray-scale backlight control signal output; and generating a RGB color-mixed signal according to the monochromatic distribution contrast average and the red, green or blue backlight control signal output.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

These features, aspects and advantages of the present invention will become better understood with regard to the following description, appended claims, and accompanying drawings, which illustrate examples of the invention. However, it is to be understood that each of the features can be used in the invention in general, not merely in the context of the particular drawings, and the invention includes any combination of these features, where:

FIG. 1 is a schematic block diagram illustrating a system of dynamic two-dimensional backlight modulation in accordance with one embodiment of the present invention;

FIG. 2 is a flow chart illustrating the control of the white light LED backlight according to one embodiment of the present invention;

FIG. 3 is a flow chart illustrating the control of the RGB LED backlight according to the present invention; and

FIG. 4 is a diagram illustrating the comparison of the intensity distribution before and after the processes of signal analysis, separation and enhancement according to one embodiment of the present invention.

### DETAILED DESCRIPTION OF THE INVENTION

The present invention relates in general to a method and system of dynamic backlight modulation about images. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

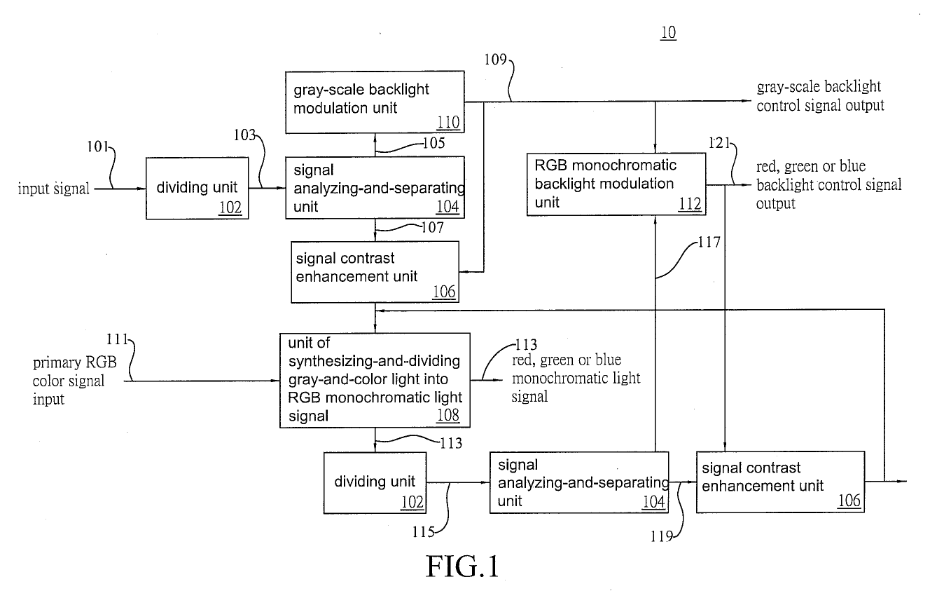

FIG. 1 is a schematic block diagram illustrating a system of dynamic two-dimensional backlight modulation in accordance with one embodiment of the present invention. The exemplary system of dynamic two-dimensional backlight modulation 10 includes a dividing unit 102, a signal analyzing-and-separating unit 104, a signal contrast enhancement unit 106, a unit of synthesizing-and-dividing gray-and-color light into RGB monochromatic light signal 108, a gray-scale backlight modulation unit 110 and a RGB monochromatic backlight modulation unit 112. The dividing unit 102 is configured for receiving an input signal 101 (gray-scale signal) and dividing the input signal 101 into a plurality of zone signals 103. The signal analyzing-and-separating unit 104, which is coupled to the dividing unit 102, is configured for receiving and analyzing the zone signals 103 for generating a distribution average 105 and a distribution contrast average 107 of the input signal 101. The gray-scale backlight modulation unit 110 electrically coupled to the signal analyzing-and-separating unit 104 is configured for receiving the gray-scale distribution average 105 and generating a gray-scale backlight control signal output 109 according to the gray-scale distribution average 105. The gray-scale backlight control signal output 109 is used to control a backlight module (not shown in the figure) for the lightness of a light source within a predetermined range.

Next, the signal analyzing-and-separating unit 104 electrically coupled to the dividing unit 102 outputs the distribution contrast average 107 to a signal contrast enhancement unit 106. The signal contrast enhancement unit 106 judges whether a maximum light level and a minimum light level corresponding to the intensity of the signal are within a default range, and adjusts backlight compensation with the gray-scale backlight control signal output 109. Accordingly, the ratio of signals may be extended to enhance the fine portion of an image on a screen. The enhanced distribution contrast average 107 is then outputted to a unit of synthesizing-and-dividing gray-and-color light into RGB monochromatic light 108. The unit of synthesizing-and-dividing gray-and-color light into RGB monochromatic light 108 compensates a primary RGB color signal input 111 for the variation of the distribution contrast 107 and converting the RGB color-mixed signal 113 by synthesizing the primary RGB color signal input 111 and the variation of the distribution contrast 107. The orientations of liquid crystals are controlled by the RGB color-mixed signal 113 to adjust a flux of RGB primary color light. The modulation technology aforementioned may be applied to white light LED backlight for a display.

Next, for the modulation of RGB color light LED backlight, a dividing unit 102 is configured for receiving the converted RGB color-mixed signal 113 from the unit of synthesizing-and-dividing gray-and-color light into RGB monochromatic light 108 and dividing the converted RGB color-mixed signal 113 receptively into a plurality of monochromatic zone signals 115. Another signal analyzing-and-separating unit 104 electrically coupled to the dividing unit 102 is configured for receiving and analyzing the zone signals 115 of each monochromatic light signal to generate a distribution average 117 and a distribution contrast average 119 of the RGB color signal input 111. The RGB monochromatic backlight modulation unit 112 electrically coupled to the signal analyzing-and-separating unit 104 is configured for receiving the distribution average 117 to generate a red, green or blue backlight control signal output 121 according to the distribution average 117. The red, green or blue backlight control signal output 121 is used to control a RGB monochromatic backlight module (not shown in the figure) for the lightness of a light source within a predetermined range. Furthermore, a signal contrast enhancement unit 106 electrically coupled to the signal analyzing-and-separating unit 104 is configured for receiving the red, green or blue color light distribution contrast average 119. The signal contrast enhancement unit 106 judges whether a maximum light level and a minimum light level corresponding to the intensity of the signal are within a default range, and adjusts backlight compensation with the red, green or blue backlight control signal output 121 to output a red, green or blue monochromatic light signal. Accordingly, the ratio of signals may be extended to enhance the fine portion of an image on a screen. The enhanced red, green or blue color light distribution contrast average 119 is outputted to the unit of synthesizing-and-dividing gray-and-color light into RGB monochromatic light 108 and then converted into the RGB color-mixed signal 113. The orientations of liquid crystals are controlled by the RGB color-mixed signal 113 to adjust a flux of RGB primary color light. The two-dimensional modulation technology aforementioned may be applied to the red, green or blue color LED backlight for a display.

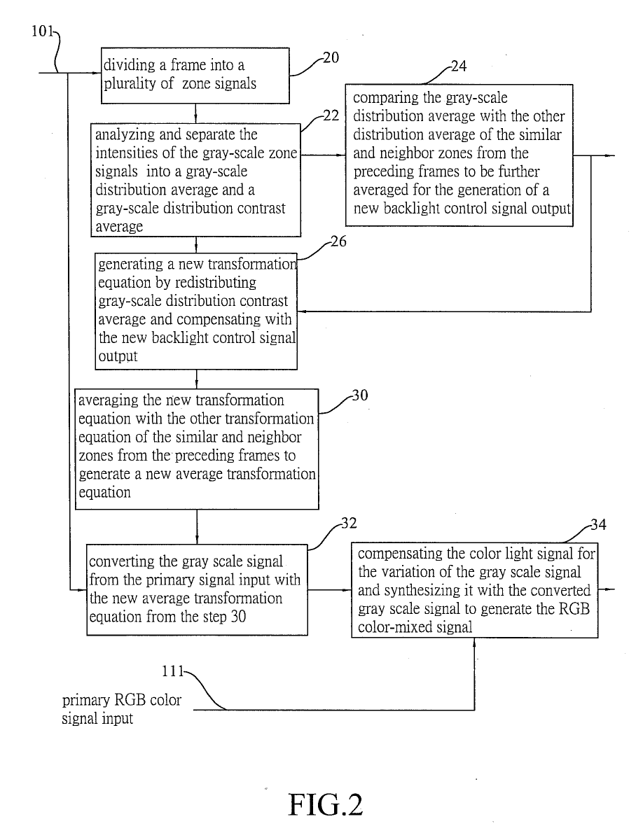

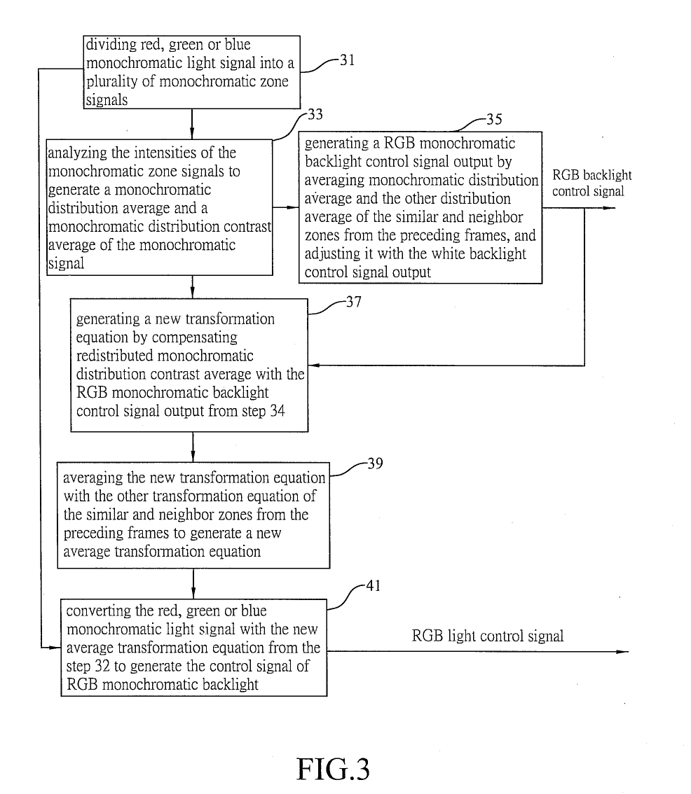

A method of dynamic contrast enhancement may be acquired according to the system aforementioned. Referring to FIG. 2 and FIG. 3, FIG. 2 is a flow chart illustrating the control of the white light LED backlight. First, a primary signal input is processed into a gray scale signal and a color light signal. The gray scale signal is divided into a plurality of gray-scale zone signals (step 20). Next, the intensities of the gray-scale zone signals are analyzed and separated to generate a gray-scale distribution average and a gray-scale distribution contrast average of the gray-scale signal (step 22). On one hand, the gray-scale distribution average is stored and compared with the other distribution average of the similar and neighbor zones from the preceding frames to be further averaged for the generation of a new backlight control signal output (step 24). On the other hand, the gray-scale distribution contrast average is stored and compared with the other distribution contrast average of the similar and neighbor zones from the preceding frames to be further redistributed. The redistributed gray-scale distribution contrast average is compensated with the new backlight control signal output from step 24 to generate a new transformation equation (step 26). The new transformation equation is stored and averaged with the other transformation equation of the similar and neighbor zones from the preceding frames to generate a new average transformation equation (step 30). The gray scale signal from the primary signal input is converted by the new average transformation equation from the step 30 (step 32). The color light signal is compensated for the variation of the gray scale signal and synthesized with the converted gray scale signal to generate the RGB color-mixed signal as the white light LED backlight control signal for liquid crystals (step 34).

FIG. 3 is a flow chart illustrating the control of the RGB LED backlight according to the present invention. The RGB color-mixed signal from the step 34 is separated into the red, green or blue monochromatic light signal. The red, green or blue monochromatic light signal is divided into a plurality of monochromatic zone signals (step 31). Next, the intensities of the monochromatic zone signals are analyzed and separated to generate a monochromatic distribution average and a monochromatic distribution contrast average of the monochromatic signal (step 33). On one hand, the monochromatic distribution average is stored and compared with the other monochromatic distribution average of the similar and neighbor zones from the preceding frames to be further averaged. The re-averaged monochromatic distribution average plus the backlight control signal output (white light backlight control signal output) from the step 24 is configured for generating a RGB monochromatic backlight control signal output (step 35). On the other hand, the monochromatic distribution contrast average is stored and compared with the other monochromatic distribution contrast average of the similar and neighbor zones from the preceding frames to be further redistributed. The redistributed monochromatic distribution contrast average is compensated with the RGB monochromatic backlight control signal output from step 34 to generate a new transformation equation (step 37). The new transformation equation is stored and averaged with the other transformation equation of the similar and neighbor zones from the preceding frames to generate a new average transformation equation (step 39). The gray scale signal from the primary signal input is converted by the new average transformation equation from the step 30 (step 32). The red, green or blue monochromatic light signal is converted by the new average transformation equation from the step 32 to be the control signal of RGB monochromatic backlight for a RGB color light LED display (step 41).

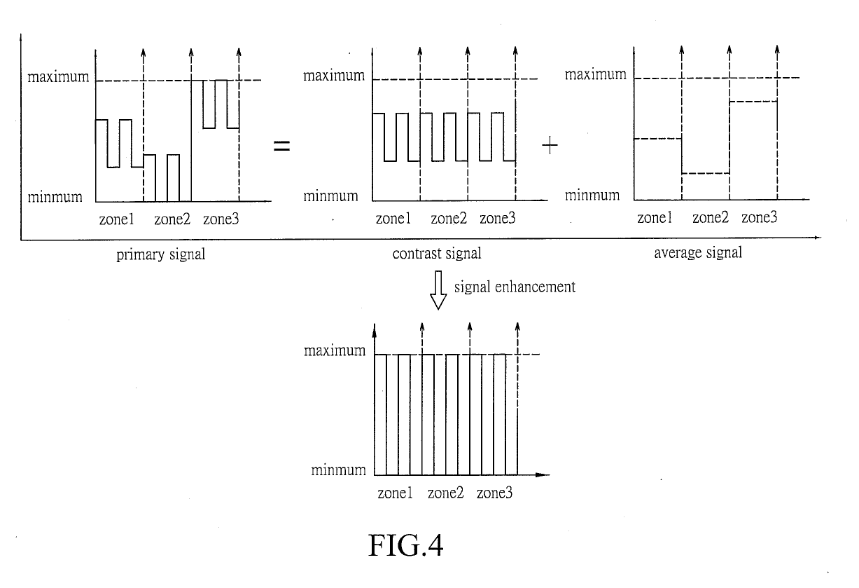

FIG. 4 is a diagram illustrating the comparison of the intensity distribution before and after the processes of signal analysis, separation and enhancement. The signal analysis-and-separating unit analyzes the zone signals to generate the distribution average and the distribution contrast. The distribution average is outputted into the signal contrast enhancement unit to judge whether a maximum light level and a minimum light level corresponding to the intensity of the signal are within a default range. The ratio of signals may be extended to enhance the fine portion of an image on a screen. For example, a darker or lighter frame from the zone signals is displayed in companied with a poor contrast in the zones and a blur display. Accordingly, the intensity range of distribution is extended by extending the ratio of signals and adjusting the signals, so as to acquire a display in fine quality and vivid gradation. The drawbacks, for example, too bright black frame or too dark bright frame, of liquid crystal display can be resolved by the modulation system of the present invention.

Although the present invention has been explained in relation to its preferred embodiment, it is to be understood that other modifications and variation can be made without departing the spirit and scope of the invention as hereafter claimed.

What is claimed is:

1. A system of dynamic backlight modulation, comprising:
a dividing unit, configured for receiving an input signal and dividing the input signal into a plurality of zone signals;
a signal analyzing-and-separating unit, electrically coupled to the dividing unit, configured for receiving and analyzing the zone signals for generating a distribution average and a distribution contrast average;
a backlight modulation unit, electrically coupled to the signal analyzing-and-separating unit, configured for receiving the distribution average and generating an backlight control signal output according to the distribution average; and
a signal contrast enhancement unit, electrically coupled to the signal analyzing-and-separating unit, configured for receiving the distribution contrast average and the backlight control signal output to generate a RGB color-mixed signal, wherein orientations of liquid crystals are controlled by the RGB color-mixed signal to adjust a flux of RGB primary color light.

2. A system of dynamic backlight modulation according to claim 1, wherein the input signal comprises a gray-scale signal and a red, green or blue monochromatic light signal.

3. A system of dynamic backlight modulation according to claim 2, wherein the backlight control signal output includes a gray-scale control signal output based on the gray-scale signal and a red, green or blue monochromatic light control signal based on the red, green or blue monochromatic light signal.

4. A system of dynamic backlight modulation according to claim 3, further comprising a unit of synthesizing-and-dividing gray-and-color light into RGB monochromatic light signal, electrically coupled to the signal contrast enhancement unit, configured for compensating a RGB color signal for a variation of a gray distribution contrast according to the gray-scale signal to convert the RGB color signal into the monochromatic light signal.

5. A system of dynamic two-dimensional backlight modulation, comprising:
a gray-scale dividing unit configured for receiving a gray-scale signal and dividing the gray-scale signal into a plurality of gray-scale zone signals;
a gray-scale signal analyzing-and-separating unit electrically coupled to the gray-scale dividing unit for receiving and analyzing the gray-scale zone signals for generating a gray-scale distribution average and a gray-scale distribution contrast average of the gray-scale signal;
a gray-scale backlight modulation unit, electrically coupled to the gray-scale signal analyzing-and-separating unit, configured for receiving the gray-scale distribution average and generating a gray-scale backlight control signal output according to the gray-scale distribution average;
a gray-scale signal contrast enhancement unit, electrically coupled to the gray-scale signal analyzing-and-separating unit, configured for receiving the gray-scale distribution contrast average and the gray-scale backlight control signal output to generate a variation of the gray-scale distribution contrast average;
a unit of synthesizing-and-dividing gray-and-color light into RGB monochromatic light signal, electrically coupled to the gray-scale signal contrast enhancement unit, configured for compensating a RGB color signal for varying the variation of the gray distribution contrast and converting the RGB color signal into the monochromatic light signal;
a monochromatic dividing unit, configured for receiving a red, green or blue monochromatic signal and dividing the red, green or blue monochromatic signal into a plurality of monochromatic zone signals;
a monochromatic signal analyzing-and-separating unit, electrically coupled to the monochromatic dividing unit, configured for receiving and analyzing the monochromatic zone signals for generating a monochromatic distribution average and a monochromatic distribution contrast average of the monochromatic signal;
a monochromatic backlight modulation unit, electrically coupled to the monochromatic signal analyzing-and-separating unit, configured for receiving the monochromatic distribution average and the gray-scale backlight control signal output to generate a red, green or blue backlight control signal output; and
a monochromatic signal contrast enhancement unit, electrically coupled to the monochromatic signal analyzing-and-separating unit, configured for receiving the monochromatic distribution contrast average and the red, green or blue backlight control signal output to generate a RGB color-mixed signal.

6. A method of dynamic two-dimensional backlight modulation, comprising:
dividing a gray-scale signal into a plurality of gray-scale zone signals;
analyzing the gray-scale zone signals for generating a gray-scale distribution average and a gray-scale distribution contrast average of the gray-scale signal;
generating a gray-scale backlight control signal output according to the gray-scale distribution average;
generating a variation of the gray-scale distribution contrast average according to the gray-scale distribution contrast average and the gray-scale backlight control signal output;
compensating a RGB color signal for varying the variation of the gray distribution contrast and converting the RGB color signal into the monochromatic light signal;
dividing a red, green or blue monochromatic signal into a plurality of monochromatic zone signals;
analyzing the monochromatic zone signals for generating a monochromatic distribution average and a monochromatic distribution contrast average of the monochromatic signal;
generating a red, green or blue backlight control signal output according to the monochromatic distribution average and the gray-scale backlight control signal output; and
generating a RGB color-mixed signal according to the monochromatic distribution contrast average and the red, green or blue backlight control signal output.
